(19) United States
(12) Patent Application Publication
(10) Pub. No.: US 2025/0282941 A1
(43) Pub. Date: Sep. 11, 2025

(54) HETEROPHASIC POLYPROPYLENE COMPOSITION WITH LOW HEXANE EXTRACTABLES

(71) Applicant: SABIC GLOBAL TECHNOLOGIES B.V., Bergen op Zoom (NL)

(72) Inventors: Christelle Marie Hélène GREIN, Aachen (DE); Henrica Norberta, Alberta, Maria STEENBAKKERS-MENTING, Susteren (NL); Désirée Marie Louise SEEGERS, Maastricht (NL); Sarah VAN MIERLOO, Opglabbeek (BE); Aaron CANCELAS, Valladolid (ES); Martin Alexander ZUIDEVELD, Kelmis (BE)

(21) Appl. No.: 18/863,821

(22) PCT Filed: May 11, 2023
(86) PCT No.: PCT/EP2023/062571

§ 371 Date: Nov. 7, 2024

(30) Foreign Application Priority Data
May 13, 2022 (EP) 22173278.7

(51) Int. Cl. C08L 23/12

(52) U.S. Cl. CPC C08L 23/12; C08L 2205/025; C08L 2207/02; C08L 2314/02

(57) ABSTRACT

The invention relates to a polypropylene composition comprising a heterophasic propylene copolymer wherein the heterophasic propylene copolymer consists of: a propylene homopolymer matrix in an amount from 71 to 92 wt %, preferably from 78 to 89 wt %, more preferably from 83 to 87 wt %, based on the heterophasic propylene copolymer and an ethylene-propylene copolymer in an amount from 8 to 29 wt %, preferably from 11 to 22 wt %, more preferably 13 to 17 wt %, based on the heterophasic propylene copolymer, wherein the amount of units derived from ethylene based on the ethylene-propylene copolymer is between 40 to 60 wt %, preferably 42 to 55 wt %, more preferably 43 to 51 wt %, and wherein the polypropylene composition has • an n-hexane extractable content measured by USA FDA 21 CFR § 177.1520; Olefin polymers (measured on film) of less than 5 wt %, wherein the heterophasic propylene copolymer within the polypropylene composition is prepared by visbreaking an intermediate heterophasic propylene copolymer having an initial melt flow rate (MFRinitial) from 1.0 to 25 dg/min, preferably 1.5 to 20 dg/min, as determined according to ISO1133: 2011 using 2.16 kg at 230° C. by contacting said intermediate heterophasic propylene copolymer in a melt mixing process with a peroxide in such an amount that a composition comprising a heterophasic propylene copolymer having the desired final melt flow rate (MFRfinal) from 3 to 45 dg/min as determined according to ISO1133: 2011 using 2.16 kg at 230° C. is obtained.

### TECHNICAL FIELD

The present invention relates to a heterophasic polypropylene composition with a low amount of low molecular weight materials that are soluble to hexane.

Further, the present invention is also directed to an article comprising the inventive polypropylene composition, preferably to an article wherein the article is prepared by injection molding and/or wherein the article is a household article, a packaging article, a healthcare article or an automotive interior article. Further, the invention relates to the use of said polypropylene composition as well as to a process for the preparation of said article.

### BACKGROUND

Polymers, like polypropylene, are increasingly used in different demanding applications. At the same time, there is a continuous search for tailored polymers which meet the requirements of these applications. The demands can be challenging, since many polymer properties are directly or indirectly interrelated, i.e. improving a specific property can only be accomplished on the expense of another property. An example of properties in polypropylene that are interrelated are impact strength and stiffness.

There is a need in the art for a polypropylene composition having a low amount of low molecular weight materials that are soluble to hexane (hexane extractables).

### SUMMARY

It is therefore an object of the present invention to provide a polypropylene composition having low amount of low molecular weight materials that are soluble to hexane (hexane extractables).

This object is achieved by a polypropylene composition comprising a heterophasic propylene copolymer wherein the heterophasic propylene copolymer consists of:
a propylene homopolymer matrix in an amount from 71 to 92 wt %, preferably from 78 to 89 wt %, more preferably from 83 to 87 wt %, based on the heterophasic propylene copolymer and
an ethylene-propylene copolymer in an amount from 8 to 29 wt %, preferably from 11 to 22 wt %, more preferably 13 to 17 wt %, based on the heterophasic propylene copolymer,
wherein the amount of units derived from ethylene based on the ethylene-propylene copolymer is between 40 to 60 wt %, preferably 42 to 55 wt %, more preferably 43 to 51 wt %, and
   wherein the polypropylene composition has
   an n-hexane extractable content of less than 5 wt % measured on film by USA FDA 21 CFR § 177.1520; Olefin polymers,
   wherein the heterophasic propylene copolymer within the polypropylene composition is prepared by visbreaking an intermediate heterophasic propylene copolymer having an initial melt flow rate (MFRinitial) from 0.5 to 50 dg/min, preferably 0.5 to 40 dg/min, more preferably 4.0 to 40 dg/min, as determined according to ISO1133:2011 using 2.16 kg at 230° C. by contacting said intermediate heterophasic propylene copolymer in a melt mixing process with a peroxide in such an amount that a composition comprising a heterophasic propylene copolymer having the desired final melt flow rate (MFRfinal) from 0.5 to 120, preferably 0.5 to 80, more preferably 5.0 to 80, even more preferably 3 to 45 dg/min as determined according to ISO1133:2011 using 2.16 kg at 230° C. is obtained.

### DESCRIPTION OF EMBODIMENTS

### Heterophasic Propylene Copolymer

The polypropylene composition according to the invention comprises a heterophasic propylene copolymer. The heterophasic propylene copolymer consists of:
a propylene homopolymer matrix in an amount from 71 to 92 wt %, preferably from 78 to 89 wt %, more preferably from 83 to 87 wt %, based on the heterophasic propylene copolymer and
an ethylene-propylene copolymer in an amount from 8 to 29 wt %, preferably from 11 to 22 wt %, more preferably 13 to 17 wt %, based on the heterophasic propylene copolymer,
the amount of units derived from ethylene based on the ethylene-propylene copolymer is between 40 to 60 wt %, preferably 42 to 55 wt %, more preferably 43 to 51 wt %.

The amount of propylene homopolymer matrix and ethylene-propylene copolymer is 100 wt % based on the heterophasic propylene copolymer. The amount of the ethylene-propylene copolymer with respect to the heterophasic propylene copolymer (herein sometimes referred as RC) and the amount of units derived from ethylene with respect to the ethylene-propylene copolymer in the heterophasic propylene copolymer (herein sometimes referred as RCC2) can be determined by 13C-NMR spectroscopy.

Preferably, the heterophasic propylene copolymer has a xylene soluble content (CXS) in the range from 8 to 21 wt %, preferably from 10 to 20 wt %, more preferably 13 to 17 wt %, wherein the xylene soluble content is measured in accordance with Crystex method described in the experimental section of the present application.

Preferably, the heterophasic propylene copolymer has a melt flow rate (MFR) in the range from 3 to 45 dg/min, wherein the melt flow rate is determined using ISO1133-1:2011 using 2.16 kg at 230° C.

the heterophasic propylene copolymer within the polypropylene composition is prepared by visbreaking an intermediate heterophasic propylene copolymer having an initial melt flow rate (MFRinitial) from 0.5 to 50 dg/min, preferably 0.5 to 40 dg/min, more preferably 4.0 to 40 dg/min, as determined according to ISO1133:2011 using 2.16 kg at 230° C. by contacting said intermediate heterophasic propylene copolymer in a melt mixing process with a peroxide in such an amount that a composition comprising a heterophasic propylene copolymer having the desired final melt flow rate (MFRfinal) from 0.5 to 120, preferably 0.5 to 80, more preferably 5.0 to 80, even more preferably 3 to 45 dg/min as determined according to ISO1133:2011 using 2.16 kg at 230° C. is obtained.

The term “visbreaking” is well known in the field of the invention. For example methods of visbreaking polypropylene have been disclosed in U.S. Pat. No. 4,282,076 and EP0063654.

Several different types of chemical reactions which are well known can be employed for visbreaking propylene polymers. An example is thermal pyrolysis, which is accomplished by exposing a polymer to high temperatures, e.g., in an extruder at 350° C. or higher. Another approach is exposure to powerful oxidizing agents. A further approach is exposure to ionizing radiation. It is preferred however that visbreaking is carried out using a peroxide. Such materials, at elevated temperatures, initiate a free radical chain reaction resulting in beta-scission of the polypropylene molecules. The visbreaking may be carried out directly after polymerisation and removal of unreacted monomer and before pelletisation (during extrusion in an extruder wherein shifting of the intermediate heterophasic propylene copolymer occurs). However, the invention is not limited to such an embodiment and visbreaking may also be carried out on already pelletised polypropylene, which polypropylene generally contains stabilisers to prevent degradation.

Examples of suitable peroxides include organic peroxides having a decomposition half-life of less than 1 minute at the average process temperature during the visbreaking step. Suitable organic peroxides include but are not limited to dialkyl peroxides, e.g. dicumyl peroxides, peroxyketals, peroxycarbonates, diacyl peroxides, peroxyesters and peroxydicarbonates. Specific examples of these include benzoyl peroxide, dichlorobenzoyi peroxide, dicumyl peroxide, di-tert-butyl peroxide, 2,5-dimethyl-2,5-di(peroxybenzoato)-3-hexene, 1,4-bis(tert-butylperoxyisopropyl)benzene, lauroyl peroxide, tert-butyl peracetate, a,a′-bis(tert-butylperoxy)diisopropylbenzene (Luperco® 802), 2,5-dimethyl-2,5-di(tert-butylperoxy)-3-hexene, 2,5-dimethyl-2,5-di(tert-butylperoxy)-hexane, tert-butyl perbenzoate, tert-butyl perphenylacetate, tert-butyl per-sec-octoate, tert-butyl perpivalate, cumyl perpivalate, cumene hydroperoxide, diisopropyl benzene hydroperoxide, 1,3-bis(t-butylperoxy-isopropyl)benzene, dicumyl peroxide, tert-butylperoxy isopropyl carbonate and any combination thereof. Preferably, a dialkyl peroxides is employed in the process according to the present invention. More preferably, the peroxide is a, a′-bis-(tert-butylperoxy)diisopropylbenzene, 2,5-dimethyl-2,5-di(tert-butylperoxy)-hexane or 3,6,9-Triethyl-3,6,9-trimethyl-1,4,7-triperoxonane. Preferably, the peroxide is selected from the group of non-aromatic peroxides.

It can easily be determined by the person skilled in the art through routine experimentation how much peroxide should be used to obtain a composition having the desired melt flow rate. This also depends on the half-life of the peroxide and on the conditions used for the melt-mixing, which in turn depend on the exact composition.

Preferably, the propylene homopolymer matrix before any step of visbreaking has a pentad isotacticity of at least 96 wt. %, preferably of at least 97 wt %, wherein the pentad isotacticity is determined using 13C NMR and/or a melt flow rate (MFR_{Hopol}) as determined according to ISO1133-1:2011 using 2.16 kg at 230° C. in the range from 0.5 to 95, preferably 0.5 to 85, more preferably 5 to 85 dg/min.

Preferably, the melt flow rate of the ethylene-propylene copolymer (MFR_{rubber}) is in the range from 0.03 to 3.0 dg/min, preferably in the range from 0.04 to 2.5 dg/min, for example in the range from 0.05 to 2.0 dg/min, wherein the MFR_{rubber} is calculated according to the following formula:

MFRrubber=10\hat{ }((Log MFheterophasic−matrix content*Log MFR_{Hopol})/(rubber content))

wherein
MFRheterophasic is the MFR (dg/min) of the heterophasic propylene copolymer measured according to ISO1133-1:2011 (2.16 kg/230° C.),
MFR_{Hopol} is the MFR (dg/min) of the propylene homopolymer matrix measured according to ISO1133-1:2011 (2.16 kg/230° C.),
matrix content is the fraction of the propylene homopolymer matrix in the heterophasic propylene copolymer,
rubber content is the fraction of the ethylene-propylene copolymer in the heterophasic propylene copolymer. For the avoidance of any doubt, Log in the formula means log 10.

Preferably, the propylene homopolymer matrix has a molecular weight distribution (Mw/Mn) in the range from 1.0 to 11.0, more preferably in the range from 4.0 to 9.0, wherein Mw stands for the weight average molecular weight and Mn stands for the number average weight and wherein Mw and Mn are measured according to ISO16014-1 (4): 2003.

### Process for the Preparation of the Heterophasic Propylene Copolymer

Heterophasic propylene copolymers are generally prepared in one or more reactors, by polymerization of propylene in the presence of a catalyst and subsequent polymerization of ethylene with α-olefins. The resulting polymeric materials are heterophasic, but the specific morphology usually depends on the preparation method and monomer ratios used.

The heterophasic propylene copolymers employed in the process according to present invention can be produced using any conventional technique known to the skilled person, for example a multistage process polymerization, such as bulk polymerization, gas phase polymerization, slurry polymerization, solution polymerization or any combinations thereof. Any conventional catalyst systems, for example, Ziegler-Natta or metallocene may be used. Such techniques and catalysts are described, for example, in WO06/010414; Polypropylene and other Polyolefins, by Ser van der Ven, Studies in Polymer Science 7, Elsevier 1990; WO06/010414, U.S. Pat. Nos. 4,399,054 and 4,472,524. Preferably, the heterophasic propylene copolymer is made using Ziegler-Natta catalyst.

The heterophasic propylene copolymer may be prepared by a process comprising—polymerizing propylene in the presence of a catalyst to obtain the propylene-based matrix and —subsequently polymerizing ethylene with α-olefins in the presence of a catalyst in the propylene-based matrix to obtain the heterophasic propylene copolymer. These steps are preferably performed in different reactors. The catalysts for the first step and for the second step may be different or same.

### Catalyst

Ziegler-Natta catalysts are well known in the art. The term normally refers to catalysts comprising a transition metal containing solid catalyst compound (procatalyst) and an organo-metal compound (co-catalyst). Optionally one or more electron donor compounds (external donor) may be present in the catalyst as well.

The transition metal in the transition metal containing solid catalyst compound is normally chosen from groups 4-6 of the Periodic Table of the Elements (Newest IUPAC notation); more preferably, the transition metal is chosen from group 4; the greatest preference is given to titanium (Ti) as transition metal.

Although various transition metals are applicable, the following is focused on the most preferred one being titanium. It is, however, equally applicable to the situation where other transition metals than Ti are used. Titanium containing compounds useful in the present invention as transition metal compound generally are supported on hydrocarbon-insoluble, magnesium and/or an inorganic oxide, for instance silicon oxide or aluminum oxide, containing supports, generally in combination with an internal electron donor compound. The transition metal containing solid catalyst compounds may be formed for instance by reacting a titanium (IV) halide, an organic internal electron donor compound and a magnesium and/or silicon containing support. The transition metal containing solid catalyst compounds may be further treated or modified with an additional electron donor or Lewis acid species and/or may be subjected to one or more washing procedures, as is well known in the art.

Some examples of Ziegler-Natta (pro) catalysts and their preparation method which can suitably be used to prepare the heterophasic propylene copolymer (A) can be found in EP 1 273 595, EP 0 019 330, U.S. Pat. No. 5,093,415, Example 2 of U.S. Pat. Nos. 6,825,146, 4,771,024 column 10, line 61 to column 11, line 9, WO03/068828, U.S. Pat. No. 4,866,022, WO96/32426A, example I of WO 2007/134851 A1 and in WO2015/091983 all of which are hereby incorporated by reference.

The (pro) catalyst thus prepared can be used in polymerization of the heterophasic propylene copolymer using an external donor, for example as exemplified herein, and a co-catalyst, for example as exemplified herein.

In one embodiment, the heterophasic propylene copolymer is made using a catalyst which is free of phthalate.

It is preferred to use so-called phthalate free internal donors because of increasingly stricter government regulations about the maximum phthalate content of polymers. In the context of the present invention, “essentially phthalate-free” or “phthalate-free” means having a phthalate content of less than for example 150 ppm, alternatively less than for example 100 ppm, alternatively less than for example 50 ppm, alternatively for example less than 20 ppm, for example of 0 ppm based on the total weight of the catalyst. Examples of phthalates include but are not limited to a dialkylphthalate esters in which the alkyl group contains from about two to about ten carbon atoms. Examples of phthalate esters include but are not limited to diisobutylphthalate, ethylbutylphthalate, diethylphthalate, di-n-butylphthalate, bis(2-ethylhexyl) phthalate, and diisodecylphthalate.

Examples of phthalate free internal donors include but are not limited to 1,3-diethers, for example 3,3-bis(methoxymethyl)-2,6-dimethylheptane, 9,9-bis (methoxymethyl) fluorene, optionally substituted malonates, maleates, succinates, glutarates, benzoic acid esters, cyclohexene-1,2-dicarboxylates, benzoates, citraconates, aminobenzoates, silyl esters and derivatives and/or mixtures thereof.

The catalyst comprising the Ziegler-Natta pro-catalyst may be activated with an activator, for example an activator chosen from the group of benzamides and monoesters, such as alkylbenzoates.

The catalyst includes a co-catalyst. As used herein, a “co-catalyst” is a term well-known in the art in the field of Ziegler-Natta catalysts and is recognized to be a substance capable of converting the procatalyst to an active polymerization catalyst. Generally, the co-catalyst is an organometallic compound containing a metal from group 1, 2, 12 or 13 of the Periodic System of the Elements (Handbook of Chemistry and Physics, 70th Edition, CRC Press, 1989-1990). The co-catalyst may include any compounds known in the art to be used as “co-catalysts”, such as hydrides, alkyls, or aryls of aluminum, lithium, zinc, tin, cadmium, beryllium, magnesium, and combinations thereof. The co-catalyst may be a hydrocarbyl aluminum co-catalyst as are known to the skilled person. Preferably, the cocatalyst is selected from trimethylaluminium, triethylaluminum, triisobutylaluminum, trihexylaluminum, di-isobutylaluminum hydride, trioctylaluminium, dihexylaluminum hydride and mixtures thereof, most preferably, the cocatalyst is triethylaluminium (abbreviated as TEAL).

Examples of external donors are known to the person skilled in the art and include but are not limited to external electron donors chosen from the group of compounds having a structure according to:

(R⁹⁰)₂N—Si(OR⁹¹)₃, Formula III:

(R⁹²)Si(OR⁹³)₃, Formula IV:

Si(OR^{a})₄₋ₙR^{b}ₙ, and Formula V:
mixtures thereof,
   wherein each of R⁹⁰, R⁹¹, R⁹² and R⁹³ groups are each independently a linear, branched or cyclic, substituted or unsubstituted alkyl having between 1 and 10 carbon atoms, preferably wherein R⁹⁰, R⁹¹, R⁹² and R⁹³ groups are each independently a linear unsubstituted alkyl having between 1 and 8 carbon atoms, wherein n can be from 0 up to 2, and each of R^{a} and R^{b}, independently, represents an alkyl or aryl group, optionally containing one or more hetero atoms for instance O, N, S or P, with, for instance, 1-20 carbon atoms.

For example the external electron donors maybe ethyl, methyl or n-propyl, for example diethylaminotriethoxysilane (DEATES), n-propyl triethoxysilane, (nPTES), n-propyl trimethoxysilane (nPTMS), diisobutyl dimethoxysilane (DiBDMS), t-butyl isopropyl dimethyxysilane (tBuPDMS), cyclohexyl methyldimethoxysilane (CHMDMS), dicyclopentyl dimethoxysilane (DCPDMS) or di(iso-propyl)dimethoxysilane (DiPDMS). More preferably, the external electron donor is chosen from the group of di(iso-propyl)dimethoxysilane (DiPDMS) or diisobutyl dimethoxysilane (DiBDMS).

Preferably, the external donor comprises or consists of a compound selected from the list comprising organo-silicon compounds, silanes, alkoxy silanes, alkyl silane, alkyl alkoxy silane and aliphatic/aromatic ester, for example dicyclopentyldimethoxysilane, di-tert-butyldimethoxysilane, methylcyclohexyldimethoxysilane, ethylcyclohexyldimethoxysilane, diphenyldimethoxysilane, diisopropyldimethoxysilane, di-n-propyldimethoxysilane, diisobutyldimethoxysilane, di-n-butyldimethoxysilane, cyclopentyltrimethoxysilane, isopropyltrimethoxysilane, npropyltrimethoxysilane, n-propyltriethoxysilane, ethyltriethoxysilane, tetramethoxysilane, tetraethoxysilane, cyclopentylpyrrolidinodimethoxysilane, bis(pyrrolidino)-dimethoxysilane, and mixtures thereof, preferentially di(iso-propyl)dimethoxysilane (DiPDMS)

Preferably, the heterophasic propylene copolymer is produced in a sequential multi-reactor polymerization process, for example in a gas-phase process, in the presence of a catalyst comprising
a) a Ziegler-Natta procatalyst comprising compounds of a transition metal of Group 4 to 6 of IUPAC, a Group 2 metal compound and an internal donor, wherein said internal donor preferably is a non-phthalic compound, more preferably a non-phthalic acid ester, even more preferably wherein said internal donor is selected from the group of for example 3,3-bis(methoxymethyl)-2,6-dimethylheptane, 9,9-bis(methoxymethyl) fluorene, optionally substituted malonates, maleates, succinates, glutarates, benzoic acid esters, cyclohexene-1,2-dicarboxylates, benzoates, aminobenzoates, silyl esters and derivatives and/or mixtures thereof; citraconates,
b) a co-catalyst (Co), and
c) optionally an external donor.

Preferably, the Ziegler-Natta procatalyst is prepared by a process comprising the steps of:
i) contacting a compound R⁴_{z}MgX⁴_{2-z} with an alkoxy- or aryloxy-containing silane compound to give a first intermediate reaction product, being a solid Mg(OR^{a})ₓX¹₂₋ₓ, wherein: R^{a} is a linear, branched or cyclic hydrocarbyl group independently selected from alkyl, alkenyl, aryl, aralkyl, alkoxycarbonyl or alkylaryl groups, and one or more combinations thereof; wherein said hydrocarbyl group may be substituted or unsubstituted, may contain one or more heteroatoms and preferably has from 1 to 20 carbon atoms; wherein R⁴ is a linear, branched or cyclic hydrocarbyl group independently selected from alkyl, alkenyl, aryl, aralkyl, alkoxycarbonyl or alkylaryl groups, and one or more combinations thereof; wherein said hydrocarbyl group may be substituted or unsubstituted, may contain one or more heteroatoms and preferably has from 1 to 20 carbon atoms, preferably R⁴ is butyl; wherein X⁴ and X¹ are each independently selected from the group of consisting of fluoride (F—), chloride (Cl—), bromide (Br—) or iodide (I—), preferably chloride; z is in a range of larger than 0 and smaller than 2, being 0<z<2, x is an integer between 0 and 2;
ii) optionally contacting the solid Mg(OR^{a})ₓX¹₂₋ₓ obtained in step i) with at least one activating compound selected from the group formed by activating electron donors and metal alkoxide compounds of formula M¹(OR^{b})_{v-w}(OR³)_{w} or M²(OR^{b})_{v-w}(R³)_{w}, to obtain a second intermediate product; wherein: M¹ is a metal selected from the group consisting of Ti, Zr, Hf, Al or Si; v is the valency of M¹; M² is a metal being Si; v is the valency of M²; R^{b} and R³ are each a linear, branched or cyclic hydrocarbyl group independently selected from alkyl, alkenyl, aryl, aralkyl, alkoxycarbonyl or alkylaryl groups, and one or more combinations thereof; wherein said hydrocarbyl group may be substituted or unsubstituted, may contain one or more heteroatoms, and preferably has from 1 to 20 carbon atoms; wherein w is smaller than v, preferably v being 3 or 4;
iii) contacting the first or second intermediate reaction product, obtained respectively in step i) or ii), with a halogen-containing Ti-compound and an internal electron donor.

In an embodiment, during step ii) as activating compounds an alcohol is used as activating electron donor and titanium tetraalkoxide is used as metal alkoxide compound.

In an embodiment, an activator is present. In an embodiment, said activator is ethyl benzoate. In an embodiment, said activator is a benzamide according to formula X:

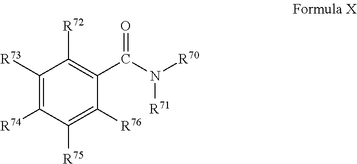

wherein R⁷⁰ and R⁷¹ are each independently selected from hydrogen or an alkyl, and R⁷², R⁷³, R⁷⁴, R⁷⁵, R⁷⁶ are each independently selected from hydrogen, a heteroatom or a hydrocarbyl group, preferably selected from alkyl, alkenyl, aryl, aralkyl, alkoxycarbonyl or alkylaryl groups, and one or more combinations thereof, more preferably wherein R⁷⁰ and R⁷¹ are both methyl and wherein R⁷², R⁷³, R⁷⁴, and R⁷⁵ are all hydrogen, being N,N′-dimethylbenzamide (Ba-2Me).

In preferred embodiments, the catalyst used for the preparation for the polypropylene composition according to the invention is the catalyst described in detail in WO2021/063930, incorporated herein by reference. The catalyst comprises a procatalyst, a co-catalyst and an external electron donor. The co-catalyst and the external electron donor may be those mentioned above.

In these preferred embodiments the internal electron donor used in the process for preparing the procatalyst is a compound according to Formula I:

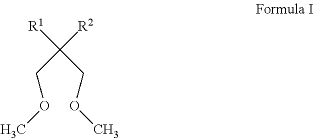

wherein R¹ is a secondary alkyl group and R² is a non-secondary alkyl group having at least 5 carbon atoms, preferably R² is a non-secondary alkyl group having at least 5 carbon atoms and being branched at the 3-position or further positions.

Preferably, the internal electron donors used are according to Formula I:

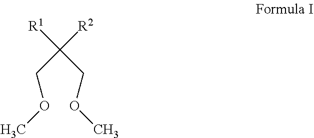

wherein R¹ is a secondary alkyl group and R² is a non-secondary alkyl group having at least 5 carbon atoms, preferably R² is a non-secondary alkyl group having at least 5 carbon atoms being branched at the 3-position or further positions. Preferably R¹ and R² have at most seven carbon atoms, preferably at most six carbon atoms, preferably R¹ and R² are independently selected from the group consisting of iso-propyl, iso-butyl, iso-pentyl, cyclopentyl, n-pentyl, and iso-hexyl.

In another embodiment, the internal electron donor is 3,3-bis(methoxymethyl)-2,6-dimethyl heptane, according to Formula I wherein R¹ is iso-propyl being secondary alkyl and R² is iso-pentyl being non-secondary and having a branch on the third carbon atom (abbreviated as iPiPen, wherein iP stands for iso-propyl and iPen stands for iso-pentyl, also known as 3-methyl-butyl). This compound iPiPen has a chemical formula of C₁₃H₂₈O₂; an exact mass of 216.21 and a molecular weight of 216.37. In a more preferred embodiment of the invention, iPiPen is used as internal donor and N,N-dimethylbenzamide is preferably used as activator.

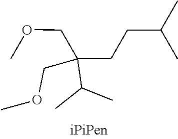

In another embodiment, the internal electron donor is (1-methoxy-2-(methoxymethyl)-5-methylhexan-2-yl)cyclopentane, according to Formula I wherein R¹ is secondary alkyl cyclopentyl and R² is secondary cyclopentyl (abbreviated as CPiPen, wherein CP stands for cyclopentyl and iPen stands for iso-pentyl, also known as 3-methyl-butyl). This compound CPiPen has a chemical formula of C₁₅H₃₀O₂; an exact mass of 242.22 and a molecular weight of 242.40. In a more specific embodiment, CPiPen is used as internal donor and N, N-dimethylbenzamide is preferably used as activator.

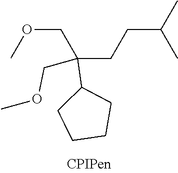 [SMILES: COCC(CCC(C)C)(COC)C1CCCC1]

In another embodiment, the internal electron donor is 3,3-bis(methoxymethyl)-2,7-dimethyloctane, according to Formula I wherein R¹ is the secondary alkyl iso-propyl and R² is non-secondary iso-hexyl with a branch on the third carbon atom (abbreviated as iPiHex, wherein iP stands for iso-propyl and iHex stands for iso-hexyl, also known as 4-methyl-pentyl). This compound iPiHex has a chemical formula of C₁₄H₃₀O₂; an exact mass of 230.22 and a molecular weight of 230.39. In a more specific embodiment, iPiHex is used as internal donor and N,N-dimethylbenzamide is used as activator.

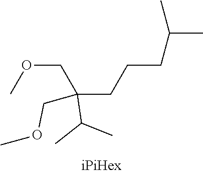 [SMILES: COCC(CCCC(C)C)(COC)C(C)C]

In another embodiment, the internal electron donor is 3,3-bis(methoxymethyl)-2-methyloctane, according to Formula I wherein R¹ is secondary alkyl iso-propyl and R² is non-secondary non-branched n-pentyl (abbreviated as iPnPen, wherein iP stands for iso-propyl and nPen stands for n-pentyl). This compound iPnPen has a chemical formula of C₁₃H₂₈O₂; an exact mass of 216.21 and a molecular weight of 216.37. In a more specific embodiment, iPnPen is used as internal donor and N,N-dimethylbenzamide is preferably used as activator.

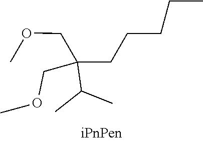

In another embodiment, the internal electron donor is 3,3-bis(methoxymethyl)-2,6-dimethyloctane, according to Formula I wherein R¹ is secondary alkyl iso-propyl and R² is non-secondary branched iso-hexyl having a branch at the third carbon atom (abbreviated as iPiHex, wherein iP stands for iso-propyl and wherein iHex stands for iso-hexyl, also known as 3-methyl-pentyl). This compound iPiHex has a chemical formula of C₁₄H₃₂O₂; an exact mass of 230.22 and a molecular weight of 230.39. In a more specific embodiment, iPiHex is used as internal donor and N,N-dimethylbenzamide is preferably used as activator.

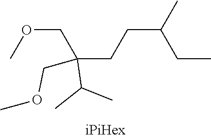 [SMILES: CCC(C)CCC(COC)(COC)C(C)C]

In an embodiment, the substituent R¹ is isopropyl or cyclopentyl. In an embodiment, the substituent R² is isopentyl or isohexyl. The below table shows the embodiments above with their abbreviations and the R¹ and R² groups as well if these groups are secondary or not and branched or not.

According to the present invention, it is further preferred that R¹ is a secondary alkyl group and R² is a non-secondary alkyl group being branched at the 3-position or further positions.

| | R¹ | | | R² | | |
|---|---|---|---|---|---|---|
| Abbrev | secondary | branched | # C | secondary | branched | # C |
| iPiPen | Yes (iP) | Yes at 1 | 3 | No (iPen) | Yes at 3 | 5 |
| CPiPen | Yes (CP) | Yes at 1 | 5 | No (iPen) | Yes at 3 | 5 |
| iPiHex | Yes (iP) | Yes at 1 | 3 | No (iHex) | Yes at 4 | 6 |
| iPnPen | Yes (iP) | Yes at 1 | 3 | No (nPen) | No | 5 |
| iPiHex | Yes (iP) | Yes at 1 | 3 | No (iHex) | Yes at 3 | 6 |

Preferably, the molar ratio of Al in the co-catalyst to Si in the external electron donor is 1 to 120, for example at least 1 and at most 15 or more than 15 and at most 120.

Preferably, the molar ratio of Si in the external electron donor to Ti in the procatalyst is 10 to 30.

Preferably, the molar ratio of Al in the co-catalyst to Ti in the procatalyst is 50 to 170.

### Composition

The polypropylene composition has a melt flow rate (MFR) in the range from 0.5 to 120, preferably 0.5 to 80, more preferably 5.0 to 80, even more preferably 3 to 45 dg/min, wherein the melt flow rate is determined using ISO1133-1:2011 using 2.16 kg at 230° C.

The polypropylene composition has an n-hexane extractable content measured by USA FDA 21 CFR § 177.1520; Olefin polymers (measured on film) of less than 5 wt %, preferably less than 2.6 wt %.

Preferably, the amount of heterophasic propylene copolymer is at least 95 wt %, preferably 96 wt %, more preferably 97 wt %, even more preferably 98 wt % based on the polypropylene composition.

### Inorganic Filler

The composition according to the invention may comprise an inorganic filler. Suitable examples of the inorganic filler include talc, calcium carbonate, wollastonite, barium sulphate, kaolin, glass flakes, laminar silicates (bentonite, montmorillonite, smectite) and mica. For example, the inorganic filler is chosen from the group of talc, calcium carbonate, wollastonite, mica and mixtures thereof. More preferably, the inorganic filler is talc.

Preferably, the inorganic filler has a median diameter d50 determined according to ISO13320-1:2020 of 5 to 20 μm, preferably 3 to 15 μm.

The composition according to the invention may be free of or substantially free of an inorganic filler. For example, the composition according to the invention may comprise less than 1.0 wt %, less than 0.1 wt % or less than 0.01 wt % of an inorganic filler.

### Additives

In some embodiments, the polypropylene composition further comprises additives, for example in an amount of 0.10 to 2.0 wt % based on the polypropylene composition.

Suitable additives include but are not limited to stabilizers. The stabilizer may e.g. be selected from heat stabilisers, anti-oxidants and/or UV stabilizers. Examples include common stabilizers such as Irgafos 168, Irganox 1010 and/or Irganox B225.

The additives may further include nucleating agents, colorants, like pigments and dyes; clarifiers; surface tension modifiers; lubricants; flame-retardants; mould-release agents; flow improving agents; plasticizers; anti-static agents; blowing agents; slip agents.

In one aspect, the invention provides an article comprising the polypropylene composition of the invention. Preferably, the amount of the polypropylene composition is at least 95 wt % based on the article. Preferably, the article is prepared by injection molding. Preferably, the article is a household article such as vacuum-cleaner housing, household chemicals and paints, or a packaging article such as containers, crates, boxes, battery case, pails, flowerpots, foodstuff containers/packaging, ice-cream container, thin wall packaging, caps and closure, healthcare packaging, or a healthcare article such as drug delivery article, laboratory ware, a medical device, a medical diagnostics article or an automotive interior article such as instrument panel carriers, door panels, dashboards, dashboard carriers, door claddings, door fixtures, armrests, pillar cladding, seat cladding, boot cladding, interior trims and applications in heating, ventilation, air conditioning (HVAC) applications.

In one aspect, the invention provides use of the polypropylene composition of the invention for the preparation of an article. Preferably, the amount of the polypropylene composition is at least 95 wt % based on the article. Preferably, the article is prepared by injection molding. Preferably, the article is a household article such as vacuum-cleaner housing, household chemicals and paints, or a packaging article such as containers, crates, boxes, battery case, pails, flowerpots, foodstuff containers/packaging, ice-cream container, thin wall packaging, caps and closure, healthcare packaging, or a healthcare article such as drug delivery article, laboratory ware, a medical device, a medical diagnostics article or an automotive interior article such as instrument panel carriers, door panels, dashboards, dashboard carriers, door claddings, door fixtures, armrests, pillar cladding, seat cladding, boot cladding, interior trims and applications in heating, ventilation, air conditioning (HVAC) applications.

In one aspect, the invention provides a process for the preparation of an article comprising the steps of:
a. providing the polypropylene composition of the invention and
b. converting the polypropylene composition into an article, for example by using an extrusion or injection molding process

In one aspect, the invention provides a process for preparing the polypropylene composition according to the invention, comprising
i) polymerizing propylene in the presence of a catalyst to obtain the propylene homopolymer matrix and
ii) subsequently polymerizing ethylene with propylene in the presence of a catalyst in the propylene homopolymer matrix to obtain the heterophasic propylene copolymer, wherein steps i) and ii) are performed in different reactors, wherein steps i) and ii) are performed in the presence of a catalyst comprising
a. a Ziegler-Natta procatalyst comprising compounds of a transition metal of Group 4 to 6 of IUPAC, a Group 2 metal compound and an internal donor, wherein said internal donor is a non-phthalic compound, more preferably a non-phthalic acid ester, even more preferably wherein said internal donor is selected from the group of for example 3,3-bis(methoxymethyl)-2,6-dimethylheptane, 9,9-bis(methoxymethyl) fluorene, optionally substituted malonates, maleates, succinates, glutarates, benzoic acid esters, cyclohexene-1,2-dicarboxylates, benzoates, citraconates, aminobenzoates, silyl esters and derivatives and/or mixtures thereof;
b. a co-catalyst (Co), and
c. optionally an external donor.

Although the invention has been described in detail for purposes of illustration, it is understood that such detail is solely for that purpose and variations can be made therein by those skilled in the art without departing from the spirit and scope of the invention as defined in the claims.

It is further noted that the invention relates to all possible combinations of features described herein, including all possible combinations of embodiments described herein, preferred in particular are those combinations of features or embodiments that are present in the claims. It will therefore be appreciated that all combinations of features or embodiment relating to the composition according to the invention; all combinations of features or embodiments relating to the process according to the invention and all combinations of features or embodiments relating to the composition according to the invention and features or embodiments relating to the process according to the invention are described herein.

It is further noted that the term ‘comprising’ does not exclude the presence of other elements. However, it is also to be understood that a description on a product/composition comprising certain components also discloses a product/composition consisting of these components. The product/composition consisting of these components may be advantageous in that it offers a simpler, more economical process for the preparation of the product/composition. Similarly, it is also to be understood that a description on a process comprising certain steps also discloses a process consisting of these steps. The process consisting of these steps may be advantageous in that it offers a simpler, more economical process.

The invention is now elucidated by way of the following examples, without however being limited thereto.

### EXAMPLES

For examples E1 and CE1: the procatalyst is prepared according to the method disclosed in WO2021/063930A1, example 1;

For examples E2 and CE2: the procatalyst is INcat P420 commercially available from INEOS Polyolefin Catalyst and prepared according to the instructions of the manufacturer.

### Process Conditions for Inventive Examples E1, E2, CE1 and CE2

Gas-phase polymerizations were performed in a set of two horizontal, cylindrical stirred bed, gas phase reactors in series to prepare the heterophasic propylene copolymers E1, E2, CE1 and CE2.

The homopolymer was formed in the first reactor (R1) and an ethylene-propylene copolymer (also referred to in the examples as “rubber” or “rubber phase”) in the second one (R2) to prepare a heterophasic propylene copolymer. Both reactors were operated in a continuous way.

During operation, polypropylene powder produced in the first reactor was discharged through a powder discharge system into the second reactor.

The temperature of the powder bed is measured via a series of internal thermocouples. The data from these thermocouples is used to control the quench flow to the individual quench nozzles.

Hydrogen was fed independently to both reactors to control a melt flow index ratio over the homopolymer powder and copolymer powder. In this respect, RCC2 is the amount of ethylene incorporated in the rubber fraction (wt %) and RC is the amount of rubber incorporated in the heterophasic propylene copolymer (wt %) determined by 13C-NMR spectroscopy.

TABLE 1
Reaction conditions of the heterophasic copolymers composition.

| | E1 | CE1 | E2 | CE2 |
|---|---|---|---|---|
| Co-catalyst | TEA | TEA | TEA | TEA |
| External donor | DiPDMS | DiPDMS | DiPDMS | DiPDMS |
| Al/Ti (mol/mol) | 88.5 | 88.5 | 120 | 120 |
| Si/Ti (mol/mol) | 17.7 | 17.7 | 12.0 | 12.0 |
| Al/Si (mol/mol) | 5 | 5 | 10 | 10 |

Reactor 1

| | | | | |
|---|---|---|---|---|
| Temp (° C.) | 68 | 68 | 68 | 68 |
| Pressure (Barg) | 22 | 22 | 22 | 22 |
| H2/C3 (mol/mol) | 0.01342 | 0.04501 | 0.01179 | 0.0407 |
| BD (kg/m3) | 411.5 | 342.5 | 396.1 | 374.2 |
| MFRhopol (dg/min) | 11.87 | 68.8 | 12.2 | 71.7 |

Reactor 2

| | | | | |
|---|---|---|---|---|
| Temp (° C.) | 63 | 63 | 63 | 63 |
| Pressure (Barg) | 22 | 22 | 22 | 22 |
| H2/C3 (mol/mol) | 0.009 | 0.067 | 0.011 | 0.07 |
| C2/C3 (mol/mol) | 0.275 | 0.483 | 0.36 | 0.49 |
| MFRinitial | 6.0 | 32.4 | 6.3 | 33.9 |

Si/Ti is the ratio of the external donor (DiPDMS) to the procatalyst
Al/Si is the ratio of the co-catalyst (TEAL) to the external donor (DiPDMS)
H2/C3 is the molar ratio of hydrogen to propylene
C2/C3 is the molar ratio of ethylene to propylene.

### Pelletization of the E3, E4, CE3 and CE4

Pellets were prepared from the powder composition E1, E2, CE1 and CE2 by extrusion process in a twin screw in order to form respectively E3, E4, CE3 and CE4.

The respective compositions of the examples E3 and E4 were prepared by extruding respectively E1 and E2 powder, respectively in a twin screw with 500 ppm Irganox 1010, 500 ppm Irgafos 168, 500 ppm CaSt, 500 ppm Mina 11, 0.025 wt % Luperox 101M050.

The respective compositions of the examples CE3 and CE4 were prepared by extruding CE1 and CE2 powder, respectively in a twin screw with (890 ppm Irganox 1010, 1780 ppm Irgafos 168, 670 ppm DHT-4A, 4500 ppm talcum, 0.043 wt % Luperox 101M050.

TABLE 2
Properties of examples E3, E4 and
comparative examples CE3 and CE4.

| | E3 | CE3 | E4 | CE4 |
|---|---|---|---|---|
| RC (wt %) | 16.2 | 18.9 | 15.1 | 18.0 |
| RCC2 (wt %) | 43.9 | 53 | 48.7 | 53.7 |
| CXS wt % | 15 | 16.9 | 14.8 | 17.1 |
| MFRfinal (dg/min) | 13.1 | 65.2 | 15.2 | 62 |
| Hexane extractable (wt %) | 2.0 | 5.1 | 2.3 | 5.4 |
| Izod 23 L 7 d (kJ/m2) | 7.16 | 5.05 | 6.9 | 5.13 |
| Izod 0 L 7 d (kJ/m2) | 4.53 | 3.51 | 4.24 | 3.62 |
| Izod −20 L 7 d (kJ/m2) | 4.06 | 3.32 | 3.87 | 3.36 |
| Flex Mod II 7 d (kJ/m2) | 1516 | 1375 | 1562 | 1309 |

### Measurement Methods

### Hexane Extractable (Wt %)

Hexane extractable was determined according to USA FDA 21 CFR § 177.1520; Olefin polymers, measured on film as follow: a sample is extracted at 50° C. in the solvent for 2 hours and filtered. The filtrate is evaporated and the total residue weighed as a measure of the solvent extractable fraction. 0.5 gram portions were extracted in 200 ml n-hexane. The results of the maximum extractable fraction in hexane are mentioned and are expressed as a percentage by weight of the polymer.

### MFR

The MFRhopol, MFRinitial and MFRfinal of the heterophasic propylene copolymer composition, the matrix phase and the dispersed phase measured according to ISO1133 using a 2.16 kg load at 230.

### Impact Strength

Impact strength was determined by measuring the Izod impact strength at 23° C., 0° C. and −20° C. according to ISO 180 4A. Test geometry: 65*12.7*3.2 mm, notch 45° according to ISO 37/2, in perpendicular orientation.

### Flexural Modulus

Flexural modulus was determined according to ASTM D790-10 at 23° C. in parallel (II) orientation. Test geometry: 65*12.7*3.2 mm.

### RC, RCC2 and TC2

RC and RCC2 were determined by 13C-NMR spectroscopy. To this end, approximately 150 mg of material was dissolved in 1,1,2,2-tetrachloroethane-d2 (TCE-d2). To ensure a homogeneous solution, the sample preparation has been conducted in a heated rotary oven. The NMR measurements were carried out in the solution-state using a Bruker 500 Advance III HD spectrometer operating at 500.16 and 125.78 MHz for 1H and 13C, respectively, and equipped with a 10 mm DUAL cryogenically-cooled probe head operating at 125° C. The 13C-NMR experiments were performed using standard single pulse excitation utilizing the NOE and bi-level WALTZ16 decoupling scheme (Zhou Z. et al. J. Mag. Reson 187 (2007) 225. A total of 512 transients were acquired per spectrum. The spectra were calibrated by setting the central signal of TCE's triplet at 74.2 ppm. Quantitative 13C NMR spectra were processed, integrated and relevant quantitative properties determined from the integrals using proprietary computer programs.

The total ethylene content (TC2) of the copolymer was calculated from the RC and RCC2.

### Crystex Method

The CRYSTEX method described in WO2019179959 and herein below can determine the following properties of a heterophasic propylene copolymer:
amount of amorphous soluble fraction in the heterophasic propylene copolymer (CXS)

The measurement of theses property may be performed according to CRYSTEX method by a CRYSTEX QC instrument of CRYSTEX QC Polymer Char (Valencia, Spain). A schematic representation of the CRYSTEX QC instrument is presented in Del Hierro, P.; Ortin, A.; Monrabal, B.; ‘Soluble Fraction Analysis in polypropylene, The Column’, February 2014. Pages 18-23.

The CRYSTEX QC instrument comprises an infrared detector (IR4) and an online 2-capillary viscometer. Quantification was done by the infrared detector which detects IR absorbance at two different bands (CH3 and CH2).

The machine was calibrated using using the Cold Xylene Soluble (CXS) and Cold Xylene Insoluble (CXI) fractions of various propylene polymers with known CXS content determined according to standard gravimetric method according to ISO16152.

### Crystex Method for Heterophasic Propylene Copolymer

A sample of the heterophasic propylene copolymer to be analyzed is weighed in concentrations of 5 mg/mL. After automated filling of the vial with 1,2,4-TCB containing 250 mg/L 2,6-tert-butyl-4-methylphenol (BHT) as antioxidant, the sample is dissolved at 170° C. until complete dissolution is achieved, for 120 min, with constant stirring of 800 rpm.

### Isotacticity ¹³C NMR

175 mg of the polypropylene pellet was dissolved in 3 ml at 130° C. in deuterated tetrachloroethylene (C2D2Cl4) containing 2,6-Di-tert-butyl-4-methylphenol (BHT) (5 mg BHT in 200 ml C2D2CL). The 13C NMR spectrum was recorded on a Bruker Avance 500 spectrometer equipped with a cryogenically cooled probe head operating at 125° C.

The isotacticity of the mmmm pentad levels was determined from the 13C NMR spectrum in % based on the total pentad amount, respectively.

### GPC/SEC

The number average molecular weight (Mn), the weight average molecular weight (Mw) and the Z average molecular weight (Mz) were determined using ISO16014-1 (4): 2003. SEC-DV was used with universal calibration. SEC measurements were performed on a PolymerChar GPC system. The samples were dissolved in 1,2,4-trichlorobenzene (TCB) stabilized with 1 g/L butylhydroxytoluene (BHT) at concentrations of 0.3-1.3 mg/mL for 4 hours at 160° C. 300 UL of polymer solution was injected and the mobile phase flow rate was 1.0 ml/min. Infrared detection IR5 MCT and a differential viscometer were used. For setting up the universal calibration line polyethylene standards were used.

1. A polypropylene composition comprising a heterophasic propylene copolymer
wherein the heterophasic propylene copolymer consists of:
a propylene homopolymer matrix in an amount from 71 to 92 wt %, based on the heterophasic propylene copolymer and
an ethylene-propylene copolymer in an amount from 8 to 29 wt %, based on the heterophasic propylene copolymer,
wherein the amount of units derived from ethylene based on the ethylene-propylene copolymer is between 40 to 60 wt %, and
wherein the polypropylene composition has
an n-hexane extractable content of less than 5 wt % measured on film by USA FDA 21 CFR § 177.1520; Olefin polymers,
wherein the heterophasic propylene copolymer within the polypropylene composition is prepared by visbreaking an intermediate heterophasic propylene copolymer having an initial melt flow rate (MFRinitial) from 0.5 to 50 dg/min, as determined according to ISO1133:2011 using 2.16 kg at 230° C. by contacting said intermediate heterophasic propylene copolymer in a melt mixing process with a peroxide in such an amount that a composition comprising a heterophasic propylene copolymer having the desired final melt flow rate (MFRfinal) from 0.5 to 120 dg/min as determined according to ISO1133:2011 using 2.16 kg at 230° C. is obtained.

2. The polypropylene composition according to claim 1, wherein the polypropylene composition has an n-hexane extractable content of less than 2.6 wt %, measured on film by USA FDA 21 CFR § 177.1520; Olefin polymers.

3. The polypropylene composition according to claim 1, wherein the polypropylene composition has a xylene soluble content (CXS) in the range from 8 to 21 wt %, wherein the xylene soluble content is measured in accordance with CRYSTEX Method for heterophasic propylene copolymer according to the description.

4. The polypropylene composition according to claim 1, wherein the propylene homopolymer matrix before any step of visbreaking has
a. a pentad isotacticity of at least 96 wt. %, the pentad isotacticity is determined using ¹³C NMR and/or
b. a melt flow rate (MFR_{Hopol}) as determined according to ISO1133-1:2011 using 2.16 kg at 230° C. in the range from 0.5 to 95 dg/min.

5. The polypropylene composition according to claim 1, wherein the amount of heterophasic propylene copolymer is at least 95 wt %, based on the polypropylene composition.

6. The polypropylene composition according to claim 1, wherein the polypropylene composition further comprises additives, for example in an amount of 0.10 to 2.0 wt % based on the polypropylene composition.

7. The polypropylene composition according to claim 1, wherein the heterophasic propylene copolymer is produced in a sequential multi-reactor polymerization process in the presence of a catalyst comprising
a. a Ziegler-Natta procatalyst comprising compounds of a transition metal of Group 4 to 6 of IUPAC, a Group 2 metal compound and an internal donor;
b. a co-catalyst (Co), and
c. optionally an external donor.

8. The polypropylene composition according to claim 7, wherein Ziegler-Natta procatalyst is prepared according to the following step:
a. contacting a compound R⁴_{z}MgX⁴_{2-z} with an alkoxy- or aryloxy-containing silane compound to give a first intermediate reaction product, being a solid Mg(OR^{a})ₓX¹₂₋ₓ, wherein: R^{a} is a linear, branched or cyclic hydrocarbyl group independently selected from alkyl, alkenyl, aryl, aralkyl, alkoxycarbonyl or alkylaryl groups, and one or more combinations thereof; wherein said hydrocarbyl group may be substituted or unsubstituted, may contain one or more heteroatoms; wherein R⁴ is a linear, branched or cyclic hydrocarbyl group independently selected from alkyl, alkenyl, aryl, aralkyl, alkoxycarbonyl or alkylaryl groups, and one or more combinations thereof; wherein said hydrocarbyl group may be substituted or unsubstituted, may contain one or more heteroatoms; wherein X⁴ and X¹ are each independently selected from the group of consisting of fluoride (F—), chloride (Cl—), bromide (Br—) or iodide (I—); z is in a range of larger than 0 and smaller than 2, being 0<z<2, x is an integer between 0 and 2;
b. optionally contacting the solid Mg(OR^{a})ₓX¹₂₋ₓ obtained in step i) with at least one activating compound selected from the group formed by activating electron donors and metal alkoxide compounds of formula M¹(OR^{b})_{v-w}(OR³)_{w} or M²(OR^{b})_{v-w}(R³)_{w}, to obtain a second intermediate product; wherein: M¹ is a metal selected from the group consisting of Ti, Zr, Hf, Al or Si; v is the valency of M¹; M² is a metal being Si; v is the valency of M²; R^{b} and R³ are each a linear, branched or cyclic hydrocarbyl group independently selected from alkyl, alkenyl, aryl, aralkyl, alkoxycarbonyl or alkylaryl groups, and one or more combinations thereof; wherein said hydrocarbyl group may be substituted or unsubstituted, may contain one or more heteroatoms; wherein w is smaller than v;
c. contacting the first or second intermediate reaction product, obtained respectively in step a) or b), with a halogen-containing Ti-compound and internal electron donor.

9. The polypropylene composition according to claim 7, wherein the internal donor is 3,3-bis(methoxymethyl)-2,6-dimethylheptane and/or wherein the activating compound is N—N-dimethylbenzamide.

10. The polypropylene composition according to claim 7, wherein the external donor is selected from the list comprising organo-silicon compounds, silanes, alkoxy silanes, alkyl silane, alkyl alkoxy silane and aliphatic/aromatic ester, for example dicyclopentyldimethoxysilane, di-tert-butyldimethoxysilane, methylcyclohexyldimethoxysilane, ethylcyclohexyldimethoxysilane, diphenyldimethoxysilane, diisopropyldimethoxysilane, di-n-propyldimethoxysilane, diisobutyldimethoxysilane, di-n-butyldimethoxysilane, cyclopentyltrimethoxysilane, isopropyltrimethoxysilane, npropyltrimethoxysilane, n-propyltriethoxysilane, ethyltriethoxysilane, tetramethoxysilane, tetraethoxysilane, cyclopentylpyrrolidinodimethoxysilane, bis(pyrrolidino)-dimethoxysilane, and mixtures thereof.

11. An article comprising the polypropylene composition of claim 1,
wherein the amount of the polypropylene composition is at least 95 wt % based on the article and/or
wherein the article is prepared by injection molding and/or,
wherein the article is a household article such as vacuum-cleaner housing, household chemicals and paints, or a packaging article such as containers, crates, boxes, battery case, pails, flowerpots, foodstuff containers/packaging, ice-cream container, thin wall packaging, caps and closure, healthcare packaging, or a healthcare article such as drug delivery article, laboratory ware, a medical device, a medical diagnostics article or an automotive interior article such as instrument panel carriers, door panels, dashboards, dashboard carriers, door claddings, door fixtures, armrests, pillar cladding, seat cladding, boot cladding, interior trims and applications in heating, ventilation, air conditioning (HVAC) applications.

12. A method of preparing an article comprising the polypropylene composition of claim 1,
wherein the amount of the polypropylene composition is at least 95 wt % based on the article and/or
wherein the article is prepared by injection molding and/or,
wherein the article is a household article such as vacuum-cleaner housing, household chemicals and paints, or a packaging article such as containers, crates, boxes, battery case, pails, flowerpots, foodstuff containers/packaging, ice-cream container, thin wall packaging, caps and closure, healthcare packaging, or a healthcare article such as drug delivery article, laboratory ware, a medical device, a medical diagnostics article or an automotive interior article such as instrument panel carriers, door panels, dashboards, dashboard carriers, door claddings, door fixtures, armrests, pillar cladding, seat cladding, boot cladding, interior trims and applications in heating, ventilation, air conditioning (HVAC) applications.

13. A process for the preparation of an article comprising the steps of
a. providing the polypropylene composition of claim 1; and
b. converting the polypropylene composition into an article, for example by using an extrusion or injection molding process.

14. A process for preparing the polypropylene composition of claim 1, comprising
i) polymerizing propylene in the presence of a catalyst to obtain the propylene homopolymer based matrix and
ii) subsequently polymerizing ethylene with propylene in the presence of a catalyst in the propylene homopolymer matrix to obtain the heterophasic propylene copolymer, wherein steps i) and ii) are performed in different reactors,
wherein the catalysts used in step i) and for the second step ii) comprise
a. a Ziegler-Natta procatalyst comprising compounds of a transition metal of Group 4 to 6 of IUPAC, a Group 2 metal compound and an internal donor;
b. a co-catalyst (Co), and
c. optionally an external donor.

15. The process according to claim 14, wherein Ziegler-Natta procatalyst is prepared according to the following step:
a. contacting a compound R⁴_{z}MgX⁴_{2-z} with an alkoxy- or aryloxy-containing silane compound to give a first intermediate reaction product, being a solid Mg(OR^{a})ₓX¹₂₋ₓ, wherein: R^{a} is a linear, branched or cyclic hydrocarbyl group independently selected from alkyl, alkenyl, aryl, aralkyl, alkoxycarbonyl or alkylaryl groups, and one or more combinations thereof; wherein said hydrocarbyl group may be substituted or unsubstituted, may contain one or more heteroatoms; wherein R⁴ is a linear, branched or cyclic hydrocarbyl group independently selected from alkyl, alkenyl, aryl, aralkyl, alkoxycarbonyl or alkylaryl groups, and one or more combinations thereof; wherein said hydrocarbyl group may be substituted or unsubstituted, may contain one or more heteroatoms; wherein X⁴ and X¹ are each independently selected from the group of consisting of fluoride (F—), chloride (Cl—), bromide (Br—) or iodide (I—); z is in a range of larger than 0 and smaller than 2, being 0<z<2, x is an integer between 0 and 2;
b. optionally contacting the solid Mg(OR^{a})ₓX¹₂₋ₓ obtained in step i) with at least one activating compound selected from the group formed by activating electron donors and metal alkoxide compounds of formula M¹(OR^{b})_{v-w}(OR³)_{w} or M²(OR^{b})_{v-w}(R³)_{w}, to obtain a second intermediate product; wherein: M¹ is a metal selected from the group consisting of Ti, Zr, Hf, Al or Si; v is the valency of M¹; M² is a metal being Si; v is the valency of M²; R^{b} and R³ are each a linear, branched or cyclic hydrocarbyl group independently selected from alkyl, alkenyl, aryl, aralkyl, alkoxycarbonyl or alkylaryl groups, and one or more combinations thereof; wherein said hydrocarbyl group may be substituted or unsubstituted, may contain one or more heteroatoms; wherein w is smaller than v;
c. contacting the first or second intermediate reaction product, obtained respectively in step a) or b), with a halogen-containing Ti-compound and internal electron donor.
